(19) United States
(12) Patent Application Publication
(10) Pub. No.: US 2025/0117421 A1
(43) Pub. Date: Apr. 10, 2025

(54) RETRIEVAL AUGMENTED GENERATION FOR HYBRID TECHNICAL SUPPORT

(71) Applicant: Insight Direct USA, Inc., Chandler, AZ (US)

(72) Inventors: David McCurdy, Centennial, CO (US); Jason Rader, Jacksonville, FL (US)

(21) Appl. No.: 18/911,846

(22) Filed: Oct. 10, 2024

Related U.S. Application Data
(60) Provisional application No. 63/543,458, filed on Oct. 10, 2023.

(51) Int. Cl. G06F 16/34; G06F 16/332

(52) U.S. Cl. CPC G06F 16/345; G06F 16/3329

(57) ABSTRACT

A method of hybrid technical support includes receiving, by a network-connected device, a first user prompt including at least one technical support query and generating, by a language model executed by the network-connected device, a first natural-language response to the first user prompt, the first natural-language response configured to elicit first additional information describing the at least one technical support query. The method further includes receiving, by the network-connected device, a second user prompt including the first additional information describing the at least one technical support query, generating a pre-summarization prompt based on the first user prompt and the second user prompt, generating a summarization of the pre-summarization prompt using a language summarization model executed by the network-connected device, and providing the summarization to a support technician device configured to be operated by a support technician. The language summarization model is configured to generate summaries of text prompts.

### CROSS-REFERENCE TO RELATED APPLICATION

This application is a nonprovisional application claiming the benefit of U.S. provisional Ser. No. 63/543,458, filed on Oct. 10, 2023, entitled “RETRIEVAL AUGMENTED GENERATION FOR HYBRID TECHNICAL SUPPORT” by D. McCurdy and J. Rader.

### FIELD OF THE INVENTION

The present disclosure relates to partially-automated technical support and, more particularly, systems and methods for machine-learning-aided hybrid technical support.

### BACKGROUND

Users in need of technical support often have multiple interactions with support providers, both in the course of resolving or attempting to resolve a single issue and more broadly over the course of a history of support interactions. In many instances, interactions between support providers and users take the form of automated interactions followed by escalation to a human technician.

### SUMMARY

An example of a method of hybrid technical support includes receiving, by a network-connected device, a first user prompt including at least one technical support query and generating, by a language model executed by the network-connected device, a first natural-language response to the first user prompt, the first natural-language response configured to elicit first additional information describing the at least one technical support query. The method further includes receiving, by the network-connected device, a second user prompt including the first additional information describing the at least one technical support query, generating a pre-summarization prompt based on the first user prompt and the second user prompt, generating a summarization of the pre-summarization prompt using a language summarization model executed by the network-connected device, and providing the summarization to a support technician device configured to be operated by a support technician. The language summarization model is configured to generate summaries of text prompts.

An example of a system for hybrid technical support includes a user device electronically-connected to a wide area network and a server electronically-connected to the wide area network. The server includes a processor and at least one memory encoded with instructions that, when executed, cause the processor to receive a first user prompt from the user device, generate a first natural-language response to the first user prompt using a language model, receive a second user prompt from the user device, generate a pre-summarization prompt based on the first user prompt and the second user prompt, generate a summarization of the pre-summarization prompt using a language summarization model executed by the processor, and provide the summarization to a support technician device electronically-connected to the server and configured to be operated by a support technician. The first user prompt includes at least one technical support query, the first natural-language response is configured to elicit first additional information describing the at least one technical support query, the second user prompt including the first additional information describing the at least one technical support query, and the language summarization model configured to generate summaries of text prompts.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for providing hybrid technical support.

FIG. 2 is a flow diagram of an example of a method of providing hybrid technical support.

FIG. 3 is a flow diagram of an example of a method of automated natural-language text generation for hybrid technical support.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for hybrid technical support and the use of machine learning language models to aid hybrid technical support to increase user satisfaction and decrease human support technician time required to resolve user technical support inquiries. As used herein, “hybrid technical support” refers to a technical support strategy that incorporates both machine-and human-generated responses to user prompts and queries. Hybrid technical support sessions according to the present disclosure incorporate both automated messages and human-generated messages that are designed, phrased, etc. to acquire necessary technical support information and provide solutions that adequately resolve user technical problems.

As will be explained in more detail subsequently, the systems and method disclosed herein enable automated generation of messages by an electronic device that can be used during an initial, automated portion of a hybrid technical support session to elicit additional diagnostic information. The additional diagnostic information solicited by the automated message generation detailed herein improves diagnostic accuracy by the support technician and reduces technician time to resolve user technical issues. Further, according to the systems and methods detailed herein, a support technician is not required to manually collect the additional diagnostic information by interacting with the user, further reducing technician time required to resolve user technical issues.

The systems and methods outlined herein also enable accurate and automated summarization of technical support messages exchanged between an automated support system and a user. When a human support technician is first introduced to a support issue, it is common for that technician to review at least a portion of prior user interactions, technician notes, and other user-or project-specific information to best assess and address the new support issue. This review process is time consuming and vulnerable to human error, especially when the support technician must attempt to extract relevant information quickly from a large volume of historical data. Support technicians may repeat questions or request data that users have already provided, but doing so risks increasing user impatience and frustration. The summarization features of the systems and methods described herein reduce the time required for a support technician to learn of a user's technical problem, the affected system, any troubleshooting steps taken, etc. and, further, reduce the need for a support technician to ask duplicative questions that may reduce the quality of user experience during a hybrid technical support session.

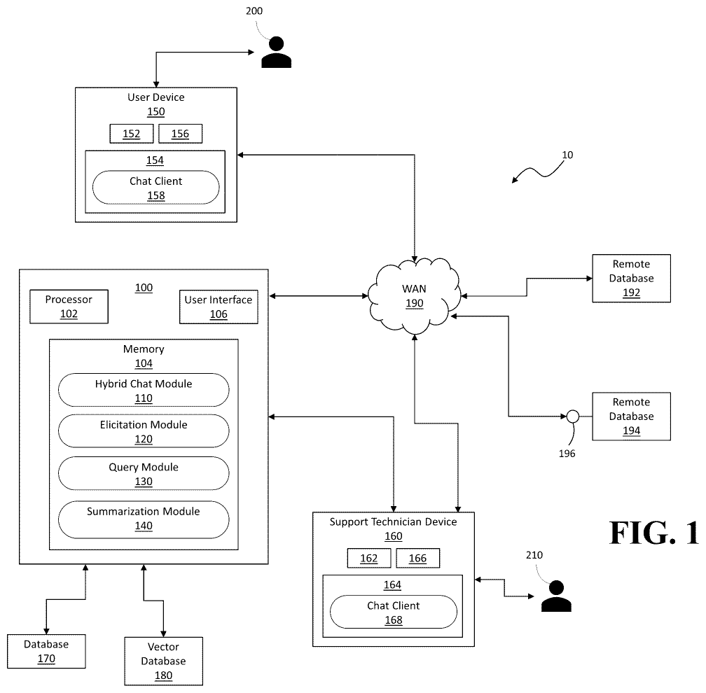

FIG. 1 is a schematic depiction of system 10, which is a system for providing hybrid technical support. System 10 includes server 100, user device 150, support technician device 160, database 170, vector database 180, wide area network (WAN) 190, remote database 192, remote database 194, and application programming interface (API) 196. Server 100 includes processor 102, memory 104, and user interface 106. Memory 104 stores hybrid chat module 110, elicitation module 120, query module 130, and summarization module 140. User device 150 includes processor 152, memory 154, and user interface 156. Support technician device 160 includes processor 162, memory 164, and user interface 166. Memory 154 and memory 164 store chat client 158 and chat client 168, respectively. FIG. 1 also depicts user 200 and support technician 210.

Server 100 is configured to perform hybrid technical support functions to resolve user technical inquiries while reducing labor required of human support technicians to provide technical support. Server 100, as will be explained in more detail subsequently, uses a machine learning language model to generate automated responses to one or more initial user prompts provided via chat client 158. The automated responses are tailored to elicit additional diagnostic information from the user related to the user's technical inquiry. Server 100 then uses another machine learning language model trained to summarize natural-language text to create a natural-language summary of the user's prompts and the automated responses generated by server 100. Advantageously, server 100 is able to perform automated generation of natural-language responses that are configured to elicit additional information from a user that is useful for solving the technical problem for which support is sought by the user. Server 100 does not require a human operator to elicit the additional information. Server 100 can then summarize the conversation history of the automated portion of the hybrid technical support session (i.e., the user prompts and the responses generated by the machine learning language model) and provide that summary to a technical support agent, who can then take over the conversation with the user.

Advantageously, the summary provided by server 100 enables the support technician ascertain the user's technical problem without requiring the support technician to manually review the entire conversation history between the user and the machine learning language model, decreasing time required for the support technician begin providing technical support following the automated portion of the hybrid technical support and/or reduces the likelihood that the support technician will request duplicative information provided to server 100 during the automated portion of the hybrid technical support. Further, the responses generated by server 100 are configured to elicit additional diagnostic information that can be used by the support technician to more quickly resolve the user's technical problem. For example, server 100 can generate common trouble-shooting steps for a particular problem, request the user provide additional hardware and/or software information, etc. The additional information elicited during the automated portion of the hybrid technical support can thereby reduce the likelihood that a support technician is required to perform common troubleshooting steps and, if a support technician is required, can reduce the time required by the support technician to accurately diagnose and provide a solution to the user's technical problem.

Server 100 is a network-connected device that is connected to WAN 190 as well as databases 150 and vector database 180. Server 100 is connected to user device 150 via WAN 190 and is optionally connected directly and/or via a local area network to support technician device 160. Although server 100 is depicted as connected to support technician device 160 directly/locally and via WAN 190, in at least some examples, server 100 is connected to support technician device 160 via one of a direct/local connection and via a WAN 190. For clarity and convenience, the arrow extending between server 100 and support technician device 160 omits other network components that can be present in system 10, but it is understood that this connection can be a direct connection, a connection via a local network, a connection via one or more network components of a local network, etc.

In some examples where server 100 is connected to support technician device 160 via WAN 190, server 100 and support technician device 160 lack a direct or local connection. In some examples, where server 100 is connected directly or locally to support technician device 160 and communicates with server 100 via the direct connection rather than via WAN 190, support technician device 160 can also be connected to WAN 190 to access other resources (e.g., servers, databases, etc.) connected to WAN 190. Server 100 also includes or more hardware elements, devices, etc. for facilitating electronic communication with WAN 190, user device 150, support technician device 160, database 170, vector database 180, a local network, and/or any other suitable device via one or more wired and/or wireless connections. Although server 100 is generally referred to herein as a server, server 100 can be any suitable network-connectable computing device for performing the functions of server 100 detailed herein.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on server 100 (e.g., by a computer-implemented machine-learning model or a data processing module) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

User device 150 is a user-accessible electronic device that is connected to server 100 via WAN 190. User device 150 includes processor 152, memory 154, and user interface 156, which are substantially similar to processor 102, memory 104, and user interface 106, respectively, and the discussion herein of processor 102, memory 104, and user interface 106 is applicable to processor 152, memory 154, and user interface 156, respectively. User device 150 includes networking capability for sending and receiving data transmissions via WAN 190 and can be, for example, a personal computer or any other suitable electronic device for performing the functions of user device 150 detailed herein. Memory 154 stores software elements of chat client 158, which will be discussed in more detail subsequently and particularly with respect to the function of hybrid chat module 110 of server 100.

Support technician device 160 is an electronic device accessible by a support technician, such as support technician 210. Support technician device can be directly-and/or locally-connected to server 100 (e.g., via a local area network), and/or can be connected to server 100 via WAN 190. Support technician device 160 can be directly-and/or locally-connected to server 100 in examples where support technician device 160 is on-site (i.e., at the same facility, campus, etc. as server 100). As described previously, in examples where support technician device 160 is directly-and/or locally-connected to server 100, support technician device 160 can also access WAN 190. In other examples, support technician device 160 is not directly-or locally-connected to server 100 and support technician 210 communicates electronically with server 100 via WAN 190.

Support technician device 160 includes processor 162, memory 164, and user interface 166, which are substantially similar to processor 102, memory 104, and user interface 106, respectively, and the discussion herein of processor 102, memory 104, and user interface 106 is applicable to processor 162, memory 164, and user interface 166, respectively. Support technician device 160 includes networking capability for sending and receiving data transmissions via WAN 190 and/or via a direct and/or local connection to server 100. Support technician device 160 can be, for example, a personal computer or any other suitable electronic device for performing the functions of support technician device 160 detailed herein. Memory 164 stores software elements of chat client 168, which will be discussed in more detail subsequently and particularly with respect to the function of hybrid chat module 110 of server 100.

Database 170 is an electronic database that is directly connected to server 100 and/or is connected to server 100 via a local network. Database 170 includes machine-readable data storage capable of retrievably housing stored data, such as database or application data. In some examples, database 170 includes long-term non-volatile storage media, such as magnetic hard discs, optical discs, flash memories and other forms of solid-state memory, or forms of electrically programmable memories (EPROM) or electrically erasable and programmable (EEPROM) memories. Database 170 organizes data using a database management system (DBMS) and can include a processor, at least one memory, and a user interface that are substantially similar to processor 102, memory 104, and user interface 106 of server 100. Database 170 is a structured database (e.g., a table or relational database) or a semi-structured database (e.g., a hierarchical and/or nested database). In at least some examples, database 170 is a relational database. Database 170 can be configured to be queryable using user identifiers, such as user credentials (e.g., credentials for accessing server 100 functionality, such as a username or password), account numbers, loyalty numbers, and/or other suitable user descriptors to retrieve stored user-specific information. Database 170 stores data describing users who access server 100 and the software modules thereof (e.g., user 200). Database 170 can store, for example, descriptive user information, such as user purchase history, user device information, or another suitable type of information for describing a user. Additionally and/or alternatively, database 170 can also store one or more templates, forms, pre-generated response text, diagnostic checklists, and/or other suitable information for use by a machine learning language model, such as a generative AI language model. When user information is updated in database 170 and/or user performs an action suitable for documentation, such as purchasing a product, purchasing a service, upgrading a product, upgrading a service level, etc., database 170 can be updated to associate with an identifier for the user (e.g., the user's account name, account number, etc.) one or more templates, forms, diagnostic checklists, etc. for common technical problems associated with that product.

Vector database 180 is an electronic database that stores vector information representative of natural-language text. The vectors stored in vector database 180 are embedded as vectors using an embedding model/algorithm that transforms natural-language text into vectors representative of the text. The vectors can represent the words of the natural-language text (e.g., word vectors) and/or any other suitable element of the text. The vectors of vector database 180 can represent any suitable length of text, such as sentences, paragraphs, etc. To query vector database 180, server 100 and/or vector database 180 can generate a vector embedding of query text and compare that vector to the vectors stored to vector database 180. The vector embedding of the query text is referred to herein as a “query vector” and the vectors of the database are referred to herein as “database vectors.” The query vector can be generated using the same embedding algorithm and/or have the same number of dimensions as the database vectors (i.e., the vectors of vector database 180). Vectors stored to vector database 180 having a similarity score above a particular threshold and/or having the highest overall similarity to the query vector can be returned in response to the query. Vector similarity can be assessed by cosine similarity, cartesian similarity, and/or any other suitable test for assessing vector similarity. The corresponding raw data (i.e., the raw text information) represented by the returned vectors and/or other natural-language text associated with the returned can then be retrieved and provided to server 100.

In some examples, vector database 180 can store vector embeddings of templates, forms, pre-generated response text, diagnostic checklists, and/or other suitable information usable by a machine learning language model to generate responses for eliciting additional diagnostic information from a user. In these examples, vector database 180 can be queried to retrieve the embedded template form, pre-generated response text, diagnostic checklist, etc. as natural text. In other examples, vector database 180 can store vector embeddings of key words, phrases, and/or likely user technical questions or problems, and can be queried to retrieve, as natural-language text, one or more templates, forms, pre-generated response text, diagnostic checklists, etc. associated with the embedded key word(s), phrase(s), and/or likely user technical question(s) or problem(s).

WAN 190 is a wide-area network suitable for connecting servers (e.g., server 100) and other computing devices that are separated by greater geographic distances than the devices of a local network. WAN 190 includes network infrastructure for connecting devices separated by larger geographic distances. In at least some examples, WAN 190 is the Internet. Server 100 can communicate with remote database 192, remote database 194, and user device 150 via WAN 190, and in some examples with service technician device 160 via WAN 190.

Remote databases 192, 194 are remotely-located databases accessible by server 100 via WAN 190. Each of remote databases 192, 194 can be substantially similar to database 170 and/or vector database 180. Remote database 192 is directly accessible (e.g., queryable) by server 100 and remote database 194 operates API 196. Server 100 can access data of database 192 by, for example, sending queries to remote database 192. Server 100 can access data of remote database 194 by sending API commands to API 196. API 196 can then query remote database 194 in response to API commands issued by server 100 and can provide data retrieved by remote database 194 in response to queries to server 100. API 194 can also perform additional database operations (i.e., operations other than retrieval) on the data of remote database 194. For explanatory clarity and simplicity, system 10 is shown as only including two remote databases 192, 194. However, system 10 can include any suitable number of remote, WAN-accessible databases. Further, for explanatory clarity and simplicity, the example of system 10 shown in FIG. 1 only depicts remote database 194 as operating an API for accessing the data of database 194. However, system 10 can include any number of remote databases that operate APIs for facilitating database access from server 100 and, in some examples, from other devices connected to WAN 190. API 196 can be any suitable API for performing database operations.

In some examples, system 10 can include additional locally- and/or directly-connected structured, semi-structured, and/or vector databases. In further examples, one or both of remote databases 192, 194 can be a structured or semi-structured database performing the same functions as database, and system 10 can lack or omit database 170. In yet further examples, one or both of remote databases 192, 194 can at least partly operate as a vector database performing the same functions as vector database 180 and system 10 can lack a separate locally-and/or directly connected vector database 180. Additionally and/or alternatively to any of the foregoing examples, system 10 can lack or omit one or both of remote database 192 and remote database 194.

Hybrid chat module 110 is a software module of server 100 and includes one or more programs executable by processor 102 for operating a chat application in conjunction with chat clients 158, 168. Hybrid chat module 110 can receive user prompts from chat client 158 and provide each prompt to elicitation module 120, query module 130, language summarization module 140, and/or support technician device 160. More specifically, while server 100 is generating automated responses to user prompts, hybrid chat module 110 can provide those prompts to elicitation module 120 and/or query module 130 in order to create automatedly-generated natural-language responses. The portion of the hybrid technical support in which hybrid chat module 110 sends automatedly-generated responses is referred to herein as the “automated portion” of the hybrid technical support. Hybrid chat module 110 can provide automatedly-generated natural-language to chat client 158 (i.e., via WAN 190) to be displayed or otherwise communicated to a user (e.g., user 200). Hybrid chat module 110 can also provide natural-language responses from the user (e.g., user 200) to chat client 168 to be displayed or otherwise communicated to support technician 210. Support technician 210 can enter a natural-language response to the user query into chat client 168 (e.g., using user interface 166). The portion of the hybrid technical support in which hybrid chat module 110 forwards or otherwise sends user messages to a support technician is referred to herein as the “human-mediated” portion of the hybrid technical support session. Chat client 168 can provide the natural-language response to the software program(s) of hybrid chat module 110, which can then provide the response to chat client 158 of user device 150. Hybrid chat module 110 can also provide a summarization of the automated portion of the hybrid technical support (i.e., of all messages sent by server 100 and user 200) created by summarization module 140 to support technician 210.

Hybrid chat module 110 begins a technical support session by providing user prompts and messages to elicitation module 120 to create automated, natural-language responses that are meant to elicit additional diagnostic information from the user (i.e., in the automated portion of the hybrid technical support). The additional diagnostic information elicited can be any information that makes or tends to make a particular technical problem diagnosis by a support technician (e.g., support technician 210) more likely. The diagnostic information can include, for example, whether a particular troubleshooting step resolved the user's technical problem. The diagnostic information can also or alternatively include, for example, additional information describing the user's technical problem, such as the existence or occurrence or a particular error, error message, etc.

Hybrid chat module 110 is configured to automatically switch to the human-mediated portion of the hybrid technical support following the automated portion of the hybrid technical support. Hybrid chat module 110 can be configured to, for example, switch from sending automated responses to forwarding user messages to a support technician after a particular number of messages are sent between the user and server. Additionally and/or alternatively, hybrid chat module 110 can also be configured to evaluate whether sufficient diagnostic information has been provided to move the hybrid technical support session from the automated portion to the human-mediated portion. During the human-mediated portion of a hybrid technical support session, hybrid chat module forwards and/or relays messages between chat client 168 of support technician device 160 and chat client 158 of user device 150, such that user 200 and support technician 210 are able to communicate and support technician 210 is able to provide technical support to user 200.

Chat clients 158, 168 are software applications that are able to provide messages to server 100 and to receive responses from server 100. Chat clients 158, 168 can be, in some examples, web browsers for accessing a web application hosted by server 100 that uses the functionality of hybrid chat module 110. Additionally and/or alternatively, chat clients 158, 168 can be specialized software applications for interacting with hybrid chat module 110 of server 100. In some examples, chat client 158 can be a web application and chat client 168 can be a specialized software application that provides additional tools, resources, etc. to the support technician. Chat clients 158, 168 are configured to receive natural-language text messages and transmit those messages to server 100 for use by hybrid chat module 110.

Messages can be submitted to chat clients 158, 168 by, for example, typing a natural-language phrase or sentence using a keyboard or a similar input device. In some examples, chat client 158, 168 can include a graphical user interface including one or more selectable graphical elements, such as one or more clickable elements and/or graphical buttons, representative of a natural-language text phrases that can be sent as messages through a chat client 158, 168. In some examples, chat client 158 and/or chat client 168 can include a graphical user interface that displays a chat history of all messages sent by a user and also replies sent by server 100 and/or a human support technician, such that a user can view previous user-submitted prompts and machine-or human-generated replies.

Elicitation module 120 is a software module of server 100 and includes one or more programs executable by processor 102 for generating automated responses to user prompts during the automated portion of the hybrid technical support session. Elicitation module 120 includes one or more machine learning language models configured to generate natural-language outputs (or indications thereof) based on user-provided prompts. The machine learning language model(s) can include one or more of a large language model or a transformer model, among other options. In some examples, the language model(s) are one or more general-purpose language models. In yet further examples, the language model(s) can be general-purpose language models with additional training for technical support and eliciting diagnostic information using a model fine-tuning approach (e.g., transfer learning approach). The responses generated by the language model(s) of elicitation module 120 are natural-language text responses, such that the user-provided messages and natural-language text responses generated by server 100 mimic a conversation between two humans.

Query module 130 is a software module of server 100 that includes one or more programs executable by processor 102 for querying database 170, vector database 180, remote database 192, and/or remote database 194 (i.e., depending on the configuration of system 10). The program(s) of elicitation module 120 can use or invoke the program(s) of query module 130 to access data stored to a database and can use that retrieved data as context to generate responses to prompts from user device 200. For example, query module 130 can query vector database 180 using all or part of a user query or message to retrieve one or more templates, forms, diagnostic checklists, etc. As an additional example, query module 130 can extract one or more key terms from a user prompt and use those key terms to query vector database 180 and/or database 170 to retrieve one or more templates, forms, diagnostic checklists, etc. Query module 130 can include, for example, one or more additional trained machine-learning models, such as one or more natural language processing model, to extract relevant key terms from the prompt. For example, query module 130 can include a natural language processing model configured to identify one or more intents and/or entities within a user prompt.

The retrieved templates, forms, diagnostic checklists, etc. can be used by the language model(s) of elicitation module 120 to structure the natural-language response provided to the user. Elicitation module 120 functions in combination with query module 130 to generate responses to user prompts that are likely to elicit a response from the user that includes additional diagnostic information usable by a support technician to decrease the total support technician time required to solve the user's technical problem.

Query module 130 and/or elicitation module 120 can, for example, create an augmented prompt including the retrieved information and the user's prompt. The language model(s) of elicitation module 120 can use the augmented prompt as an input to create a response to the user's prompt that incorporates the retrieved information. The data stored to the queried data store (e.g., database 170, vector database 180) is selected to include natural-language text that is structured, composed, etc. to be used by a machine learning language model to create a response that is likely to elicit additional diagnostic information from users. Accordingly, the augmented prompt causes the language model(s) to create a natural-language output that is likely to elicit additional diagnostic information from the user regarding their technical problem. The output can solicit the user to provide, for example, additional information describing the product for which technical support is being sought, information describing initial troubleshooting the user has performed, and/or directions for performing additional troubleshooting steps, among other options.

Elicitation module 120 and query module 130 can be used in combination to create multiple responses to successive user messages in order to elicit additional information from the user. Additional responses can use the same retrieved information where, for example, user replies are not fully responsive to (e.g., do not provide all requested information, do not answer all diagnostic questions, etc.) to the responses generated by elicitation module 120. Query module 130 can retrieve new information for generating additional responses with elicitation module 120 where, for example, a new user message (i.e., a message subsequent to a response generated by server 100) indicates a new technical problem and/or provide information sufficient to further classify the technical problem.

Summarization module 140 is a software module of server 100 and includes one or more programs for generating a natural-language summary of messages sent by the user (e.g., user 200) and server 100 (i.e., messages generated by elicitation module 120) during the automated portion of the hybrid technical support session. Summarization module 140 includes one or more machine learning language models configured to generate natural-language outputs (or indications thereof) based on user-provided prompts. The machine learning language model(s) can include one or more of a large language model or a transformer model, among other options. The machine learning language model(s) of summarization module 140 is configured to generate a natural- language summary suitable for use by a human support technician (e.g., support technician 210). The machine learning language model can be a different machine learning language model than the model used by elicitation module 120 to create natural-language responses to mimic human responses to user messages. Summarization module 140 retrieves a copy of the chat history between server 100 (i.e., messages generated using elicitation module 120) and messages generated and sent by a user from chat application 158 and/or from memory 104 (i.e., in examples where server 100 stores a copy of user chat history) and uses the chat history as an input to the language model used for summarization. The output from the language model can be transmitted to support technician device 160 and read by the support technician (e.g., support technician 210).

The chat summary created by summarization module 140 summarizes the message exchanged between the user and server 100 during the automated portion of the hybrid technical support session, including the additional diagnostic information provided from the user responses to the messages generated by elicitation module 120. That is, the chat summary created by summarization module 140 includes all relevant information (i.e., relevant to technical support) exchanged between the support technician and the user, but is shorter in length than the entire chat history such that the summary has fewer words, sentences, and/or characters than the chat history. The summary can also be composed by the machine learning language model in a manner to promote readability to reduce the amount of time the support technician needs to read and understand the contents of the summary. For example, the summary can be written in a narrative format.

The support technician can use the chat summary to more rapidly understand the user's technical problem and the additional diagnostic information provided by the user to server 100 in response to the automated messages from server 100 as compared to manually inspecting the chat history summarized by summarization module 140. In some examples, the chat summary provided by summarization module 140 can also summarize any additional troubleshooting, as well as user responses describing the results of that additional troubleshooting, recommended during the automated portion of the hybrid technical support session. After the support technician has read the summary created by summarization module 140, the support technician can provide additional technical support during the human-mediated portion of the hybrid technical support session.

As described previously, elicitation module 120 enables automated response generation to elicit additional diagnostic information from a user seeking technical support. The automated responses created by elicitation module 120 reduce the total support technician time required to solve a user's technical problem, thereby reducing costs associated with technical support. Summarization module 140 also reduces technician time required to solve user technical problems by reducing the time required to transition from the automated portion to the human-mediated portion of the hybrid technical support session.

In combination, elicitation module 120/query module 130 and summarization module 140 provide further improvements to technical support quality and reductions in technician time to resolve user technical problems than systems that include only one of elicitation module 120 and summarization module 140. Notably, the combination of elicitation module 120 and summarization module 140 provide reductions in technician time required to solve user technical problems without requiring users to provide the same information repeatedly (e.g., during both portions of the hybrid technical support), provide non-diagnostic information, or perform other tasks that reduce user experience. To this extent, as compared to other systems, the combination of elicitation module 120/query module 130 and summarization module provide significant reductions to operational costs for technical support providers that do not also have negative impacts on user experience.

Although system 10 is depicted as including only one user device (i.e., user device 150) and one support technician device (i.e., support technician device 160), in other examples, system 10 can include any number of user devices and support technician devices. FIG. 1 depicts only one user device and one support technician device for illustrative clarity and convenience, but server 100 can be connected to any suitable number of user devices and support technician devices. In some examples, system 10 can also include any suitable system, such as a hunt group or an equivalent system, assigning support technician devices to hybrid technical support sessions (i.e., for assigning a support technician to a particular user's hybrid technical support session).

In some examples, summarization module 140 can also be used to summarize prior human-mediated technical support sessions between the user and one or more support technicians. Summarization module 140 can retrieve prior text transcripts of one or more prior conversations between the user and one or more support technicians and can summarize those text transcripts as part of the summary of the automated technical support provided by server 100 and/or as a separate summary. The summary information can be used by a support technician to understand prior human-mediated technical support received by the user without requiring the user to attempt to remember those technical support sessions and/or generate a written summary of those technical support sessions. Summaries of prior human-mediated technical support conversations can provide several advantages. For example, summaries of prior human-mediated support be used by support technicians to avoid solutions that the user has already tried and that were unsuccessful, thereby decreasing the likelihood of user frustration in the human-mediated portion of a hybrid technical support session. As an additional example, summaries of prior human-mediated support can be used by support technicians to better understand user qualities, such as temperament, technical experience level, etc.

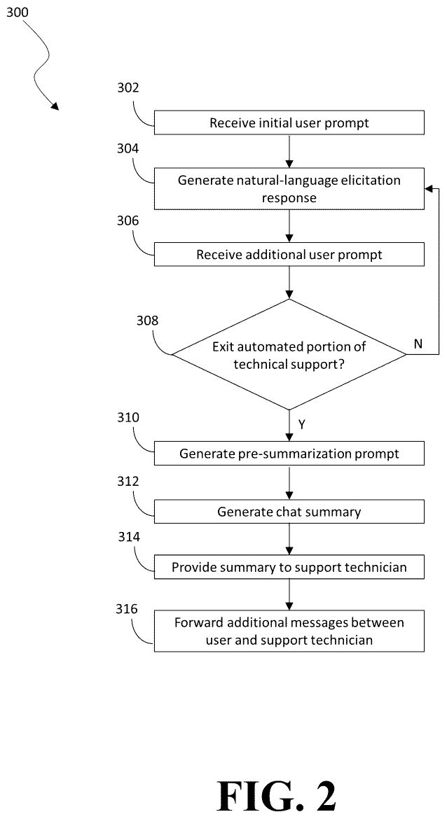

FIG. 2 is a flow diagram of method 300, which is a method of hybrid technical support performable by server 100 of system 10 (FIG. 1). Method 300 includes steps 302-316 of receiving an initial user prompt (step 302), generating a natural language elicitation response (step 304), receiving an additional user prompt (step 306), determining whether to exit the automated portion of the technical support session (step 308), generating a pre-summarization prompt (step 310), generating a chat summary (step 312), providing a summary to a support technician (step 314), and forwarding additional messages between the user and the support technician (step 316). Method 300 performable by server 100 of system 10 and is described herein with reference to system 10 (FIG. 1), but method 300 can be implemented in any suitable system to enable hybrid technical support according to the present disclosure.

In step 302, server 100 receives a user prompt from a user device, such as user device 150. The prompt is natural-language text (e.g., a text string) that includes a natural-language representation of one or more user questions and/or statements describing and/or relating to a technical problem the user is experiencing. A user can enter a message describing a technical problem the user is experiencing into a chat client configured to interact with and use functionality of server 100 (e.g., chat client 158), and the chat client can provide the message to server 100. The received message is the prompt received in step 302. Additionally and/or alternatively, server 100 can remove portions of the user message, such as extraneous filler words, and use the resulting natural-language text as the prompt.

In step 304, server 100 generates a natural-language elicitation response based on the user prompt received in step 304. The elicitation response generated in step 304 is generated in an automated manner by server 100 and is intended (e.g., via text structure, phrasing, etc.) to elicit additional diagnostic information from the user from whom the prompt was received in step 302. Server 100 uses the user prompt received in step 302 as an input to a machine learning language model configured to generate conversational responses based on natural-language inputs. Server 100 can query one or more databases based on, for example, a user identifier received from the user device and/or the user prompt to retrieve data that can be used to provide context to the machine learning language model during response generation (i.e., via retrieval-augmented generation). The database(s) can be, for example, structured, semi-structured, and/or vector database(s). The database is queried to retrieve one or more templates, forms, diagnostic checklists, etc. that can be used by the language model to form a response that is likely to cause the user to provide further diagnostic information (i.e., diagnostic information different than any diagnostic information provided in the user's most recent message). The text response generated in step 304 (or an indication thereof) is transmitted to the user's device (e.g., user device 150) and displayed or otherwise communicated to the user by a chat client operating on that device (e.g., chat client 158). In at least some examples, the chat client causes the user device to display a natural-language representation of the text response generated in step 304.

In examples where a user identifier is received in step 302 and used in step 304, the user identifier can be, for example, an account name, an access credential (e.g., a username), an account number, the user's personal name (e.g., a first and/or last name), etc. In some examples, a user can submit access credentials (e.g., a username, password, etc.) to the chat client and the chat client can verify that the user is approved to access server 100 functionality by validating the provided credentials with credentials stored to server 100. The chat client can store or retain an identifier for the user and can provide that identifier as the user identifier with prompts submitted by the user to server 100.

In step 306, server 100 receives an additional user prompt. The prompt received in step 306 is received after the text response generated in step 304 is provided to the user's device. The additional user prompt received in step 306 and is also natural-language text (e.g., a natural-language text string). In at least some examples, the additional user prompt includes additional diagnostic information that can be used by server 100 (i.e., in further iterations of steps 304-306) and/or a support technician to provide technical support to the user.

In step 308, server 100 determines whether to exit the automated portion of the hybrid technical support session. If server 100 determines to exit the automated portion, method 300 proceeds to step 310. If server 100 determines that the automated portion should not be exited, method 300 proceeds to step 304 and performs an additional iteration of steps 304-306. In the additional iterations of steps 304-306, server 100 creates a further response based, at least in part, on the most-recently received user response (i.e., the response provided in the most recent iteration of step 306). Method 300 then proceeds to step 306 to receive an additional prompt from the user. Server 100 can exit the automated portion of the hybrid technical support session after, for example, a pre-determined number of iterations of steps 304-306. In at least some examples, server 100 is configured to only perform one iteration of steps 304-306, such that server 100 only provides one response to the user that is generated by elicitation module 120 in a single hybrid technical support session. In other examples, server 100 can inspect the chat history between the user and server 100 to determine whether to exit the automated portion of the hybrid technical support session.

In step 310, server 100 generates a pre-summarization prompt. The pre-summarization prompt includes at least the user messages provided during step 302 and the iterations of step 306, and in some examples includes all text exchanged between server 100 and the user during steps 302-306 (including all iterations of step 304). In at least some examples, server 100 can generate the pre-summarization prompt by retrieving the chat history between server 100 and the user and converting the chat history to a text format usable by a language summarization model in subsequent step 312.

In step 312, server 100 generates a summary of the chat history between server 100 (i.e., messages generated by elicitation module 120) and the user. The summary is generated by using the pre-summarization prompt created in step 310 as an input to a machine learning language model trained or otherwise configured to summarize natural-language text information. The machine learning language model used in step 312 can be referred to as a “summarization model” or a “language summarization model” and, in at least some examples, is a different machine learning language model than the machine learning language model used in step 304 to generate elicitation responses. Step 312 generates a natural-language summary that is shorter in length than the chat history being summarized (i.e., having fewer sentences, words, characters, etc.). The natural-language summary generated in step 312 enables a human support technician to understand the user's technical problem, including any additional troubleshooting steps performed during steps 312-316, without requiring the support technician to read the entire chat history between server 100 and the user. To this extent, the summary generated in step 314 reduces the time required for a support technician to bring a user technical problem to a satisfactory resolution.

In step 314, the summary generated in step 312 is provided to the support technician assigned to the hybrid technical support session. The summary can be provided by, for example, transmitting the natural-language output of the language summarization model (or an indication thereof) to an electronic device operated by the support technician. A chat client operating on the support technician can cause the support technician device to display or otherwise communicate the summary to the support technician.

Step 316 is optional and is performed in examples where server 100 relays messages between a user and a support technician. In step 316, server 100 forwards additional messages between the support technician and the user as part of the human-mediated portion of the hybrid technical support. The support technician can, for example, enter one or more messages to the user into the chat client and the support technician device can communicate those messages to server 100, which can then forward those messages to the user device. Similarly, the user can, for example, enter one or more messages to the support technician into the chat client and the user device can communicate those messages to server 100, which can then forward those messages to the support technician device. The chat clients operating on the user device and the support technician device can cause received messages to be displayed and/or communicated to the user and the support technician, respectively.

Advantageously, method 300 enables hybrid technical support sessions that reduce the total human support technician time required to solve user technical problems. Steps 302-308 allow a computer device to automatically and automatedly generate natural-language responses that elicit additional diagnostic information from a user and, accordingly, reduce technician time required to solicit that diagnostic information from the user. Further, steps 310-312 allow for the automated and automatic generation of natural-language support summaries that outline and summarize the chat history between the user and the electronic device (i.e., the automated messages generated by the device) during the automated portion of the hybrid technical support session. The summaries created in steps 310-312 further reduce the overall technician time required to solve the user's technical problem, as the summaries generated in steps 310-312 allow a support technician to become adequately apprised of the user's technical problem without requiring the support technician to manually review entire the chat history generated during the automated portion of the hybrid technical support session.

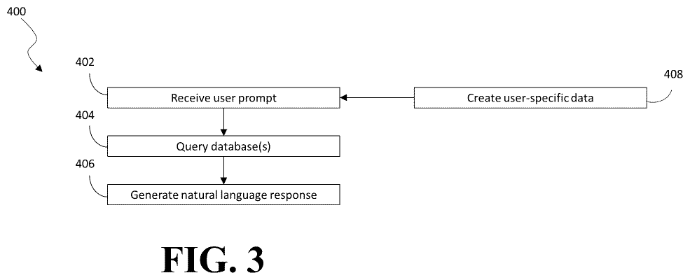

Method 400 is a method of generating an elicitation response and can be used as part of method 300 (FIG. 3) to generate the elicitation response in step 304. Method 400 includes steps of receiving a user prompt (step 402), querying database(s) (step 404), generating a natural language response (step 406), and creating user-specific data (step 408). Method 400 outlines the manner in which user-specific information, such as a user identifier, can be used to query databases for language generation and, further, to create database data that can be subsequently retrieved during language generation in step 304 of method 300. Method 400 performable by server 100 of system 10 and is described herein with reference to system 10 (FIG. 1), but method 400 can be implemented in any suitable system to enable hybrid technical support according to the present disclosure.

In step 402, a user prompt is received by server 100. The user prompt can be a user prompt received in step 302 and/or step 306, such that step 402 can be substantially the same as step 302 and/or step 306. The user identifier includes, in at least some examples, a user identifier, such as an account number, a username, etc.

In step 404, server 100 queries one or more databases to obtain additional context for creating a natural-language reply. Server 100 can, for example, query a vector database (e.g., vector database 180) with the user's prompt to obtain one or more forms, templates, diagnostic checklists, etc. that can be used by elicitation module 120 to structure a natural-language response for eliciting additional diagnostic information from the user. Server 100 can also, for example, use the user identifier to query one or more structured or semi-structured databases to retrieve user-specific information, and use the retrieved user-specific information to retrieve one or more forms, templates, diagnostic checklists, etc. For example, server 100 can query a database (e.g., database 170) to retrieve a history of products purchased by the user to understand what product the user may be seeking technical support for. Where the user has more than one relevant purchase, server 100 can, for example, use a natural language processing model or another suitable algorithm to identify a product in the user's prompt and match that identified product to a product in the user's purchase history. Server 100 can then use the product information to query another database to retrieve one or more forms, response templates, diagnostic checklists, etc. for that product.

As a further example, server 100 can also use a user identifier for a user to determine, for example, a user's account status. For example, if a user has a particular account status (e.g., a “gold level” or “platinum level” account), it can improve user experience for at least one message during the automated portion of the hybrid technical support session to acknowledge that account status.

In some examples, forms, response templates, diagnostic checklists, etc. can be stored to a database and retrieved using a user-specific identifier. For example, when a user purchases a particular product or enrolls in a particular service or account level, server 100 or another electronic computing device can automatically create database data containing relevant prompts, forms, diagnostic checklists, etc. that are specific to that the user's purchase, service level, account level, etc. can be retrieved based on the user's identifier and without having to query multiple databases and/or query a vector database.

Step 406 of method 400 can be performed in substantially the same manner as step 304 of method 300. Server 100 can combine the prompt received in step 402 (i.e., a prompt received in step 302 and/or 306 of method 300; FIG. 3) with the template, form, diagnostic checklist, etc. received in step 404 to create an input for the machine learning language model(s) used to generate the elicitation response. In examples where a user account status, account level, service level etc. is retrieved in step 404, server 100 can also combine that information with the prompt and the template, form, checklist, etc. to create an input for the machine learning language model(s).

Step 408 is an optional step of method 300 and is performed in examples one or more forms, templates, diagnostic checklists, etc. are stored to a database and associated with a user identifier based on the user's purchase(s), account status, account level, service level, etc. In step 408, server 100 and/or another suitable electronic computing device recognizes that a transaction (e.g., the purchase of a product, account level, service level, etc.) has occurred for which a technical support template, form, diagnostic checklist, etc. exists. Server 100 then stores the appropriate technical support template, form, diagnostic checklist, etc. to a database and associates the new data with the user's identifier.

### Discussion of Possible Embodiments

The following are non-exclusive descriptions of possible embodiments of the present invention.

A method of hybrid technical support, the method comprising: receiving, by a network-connected device, a first user prompt including at least one technical support query; generating, by a language model executed by the network-connected device, a first natural-language response to the first user prompt, the first natural-language response configured to elicit first additional information describing the at least one technical support query; receiving, by the network-connected device, a second user prompt including the first additional information describing the at least one technical support query; generating a pre-summarization prompt based on the first user prompt and the second user prompt; generating a summarization of the pre-summarization prompt using a language summarization model executed by the network-connected device, the language summarization model configured to generate summaries of text prompts; and providing the summarization to a support technician device configured to be operated by a support technician.

The method of the preceding paragraph can optionally include, additionally and/or alternatively, any one or more of the following features, configurations and/or additional components:

A further embodiment of the foregoing method, wherein generating the pre-summarization prompt comprises generating the pre-summarization prompt based on the first user prompt, the second user prompt, and the first natural-language response.

A further embodiment of the foregoing method, wherein: receiving, by the network-connected device, the first user prompt comprises: receiving, by a chat client operated by a user device in electronic communication with the network-connected device, a first natural-language text input from the user; and transmitting, by the user device, the first user prompt to the network-connected device; generating the first-natural language response comprises: transmitting, by the network-connected device, the first-natural language response to the user device; and displaying, by the chat client operated by the user device, an indication of the first-natural language response to the user; and receiving, by the network-connected device, the second user prompt comprises: receiving, by the chat client operated by the user device, a second natural-language text input from the user; and transmitting, by the user device, the second user prompt to the network-connected device.

A further embodiment of the foregoing method, wherein providing the summarization to the support technician device comprises transmitting, by the network-connected device, the summarization to the support technician device.

A further embodiment of the foregoing method, and further comprising displaying, by the support technician device, an indication of the summarization to the support technician.

A further embodiment of the foregoing method, wherein generating the first natural-language response comprises: creating a vector embedding of the first user prompt; querying a vector database with the vector embedding of the first user prompt to retrieve a response elicitation template; creating a modified prompt by combining the response elicitation template and the first user prompt; and generating the first natural-language response based on the modified prompt.

A further embodiment of the foregoing method, wherein generating the first-natural language response comprises: receiving, by the network-connected device, a user identifier for the user; querying, by the network-connected device, a first database using the user identifier to retrieve first information for the user; querying a second database using the first information to retrieve a response elicitation template; creating a modified prompt by combining the response elicitation template and the first user prompt; and generating the first natural-language response based on the modified prompt.

A further embodiment of the foregoing method, wherein the first information is at least one of an account type, an account status, a recent purchase, and a service subscription.

A further embodiment of the foregoing method, and further comprising querying a third database using the user identifier to retrieve second information for the user, and wherein creating the modified prompt comprises combining the response elicitation template, the first user prompt, and the second information.

A further embodiment of the foregoing method, wherein the second user information is second user information is a different at least one of the account type, the account status, the recent purchase, and the service subscription.

A further embodiment of the foregoing method, and further comprising, prior to receiving the first user prompt, storing one or more natural-language text segments to a first database based on a user identifier for the user, and wherein generating the first-natural language response comprises: receiving, by the network-connected device, the user identifier for the user; querying, by the network-connected device, the first database using the user identifier to retrieve a response elicitation template; creating a modified prompt by combining the response elicitation template and the first user prompt; and generating the first natural-language response based on the modified prompt.

A further embodiment of the foregoing method, wherein the user identifier is at least one of a username, an account number, an account type, a recent purchase, and a service subscription.

A further embodiment of the foregoing method, and further comprising: generating, by the language model executed by the network-connected device, a second natural-language response to the second user prompt, the second natural-language response configured to elicit second additional information describing the at least one technical support query; and receiving, by the network-connected device, a third user prompt including the second additional information describing the at least one technical support query, wherein generating the pre-summarization prompt for the language summarization model comprises generating the pre-summarization prompt based on the first user prompt, the second user prompt, and the third user prompt.

A further embodiment of the foregoing method, wherein generating the pre-summarization prompt comprises generating the pre-summarization prompt based on the first user prompt, the second user prompt, the third user prompt, the first natural-language response, and the second natural-language response.

A further embodiment of the foregoing method, and further comprising: displaying, by the support technician device, an indication of the summarization; and receiving, after displaying the indication of the summarization, a technician response at the support technician device, the technician response comprising one or more natural-language text segments describing a support solution for the at least one technical support query.

A further embodiment of the foregoing method, and further comprising: transmitting the technician response from the support technician device to the user device; and displaying, by the user device, an indication of the technician response.

A system for hybrid technical support, the system comprising: a user device electronically-connected to a wide area network; a server electronically-connected to the wide area network, the server comprising: a processor; and at least one memory encoded with instructions that, when executed, cause the processor to: receive a first user prompt from the user device, the first user prompt including at least one technical support query; generate a first natural-language response to the first user prompt using a language model, the first natural-language response configured to elicit first additional information describing the at least one technical support query; receive a second user prompt from the user device, the second user prompt including the first additional information describing the at least one technical support query; generate a pre-summarization prompt based on the first user prompt and the second user prompt; generate a summarization of the pre-summarization prompt using a language summarization model executed by the processor, the language summarization model configured to generate summaries of text prompts; and provide the summarization to a support technician device electronically-connected to the server and configured to be operated by a support technician.

The system of the preceding paragraph can optionally include, additionally and/or alternatively, any one or more of the following features, configurations and/or additional components:

A further embodiment of the foregoing system, wherein the instructions, when executed, cause the processor to generate the pre-summarization prompt based on the first user prompt, the second user prompt, and the first natural-language response.

A further embodiment of the foregoing system, and further comprising the support technician device, and wherein the instructions, when executed, cause the processor to provide the summarization to the support technician device by causing the server to transmit the summarization to the support technician device.

A further embodiment of the foregoing system, and further comprising a vector database electronically-connected to the server, and wherein the instructions, when executed, cause the processor to: create a vector embedding of the first user prompt; query a vector database with the vector embedding of the first user prompt to retrieve a response elicitation template; create a modified prompt by combining the response elicitation template and the first user prompt; and generate the first natural-language response based on the modified prompt.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of hybrid technical support, the method comprising:
receiving, by a network-connected device, a first user prompt including at least one technical support query;
generating, by a language model executed by the network-connected device, a first natural-language response to the first user prompt, the first natural-language response configured to elicit first additional information describing the at least one technical support query;
receiving, by the network-connected device, a second user prompt including the first additional information describing the at least one technical support query;
generating a pre-summarization prompt based on the first user prompt and the second user prompt;
generating a summarization of the pre-summarization prompt using a language summarization model executed by the network-connected device, the language summarization model configured to generate summaries of text prompts; and
providing the summarization to a support technician device configured to be operated by a support technician.

2. The method of claim 1, wherein generating the pre-summarization prompt comprises generating the pre-summarization prompt based on the first user prompt, the second user prompt, and the first natural-language response.

3. The method of claim 1, wherein:
receiving, by the network-connected device, the first user prompt comprises:
receiving, by a chat client operated by a user device in electronic communication with the network-connected device, a first natural-language text input from the user; and
transmitting, by the user device, the first user prompt to the network-connected device;
generating the first-natural language response comprises:
transmitting, by the network-connected device, the first-natural language response to the user device; and
displaying, by the chat client operated by the user device, an indication of the first-natural language response to the user; and
receiving, by the network-connected device, the second user prompt comprises:
receiving, by the chat client operated by the user device, a second natural-language text input from the user; and
transmitting, by the user device, the second user prompt to the network-connected device.

4. The method of claim 2, wherein providing the summarization to the support technician device comprises transmitting, by the network-connected device, the summarization to the support technician device.

5. The method of claim 4, and further comprising displaying, by the support technician device, an indication of the summarization to the support technician.

6. The method of claim 1, wherein generating the first natural-language response comprises:
creating a vector embedding of the first user prompt;
querying a vector database with the vector embedding of the first user prompt to retrieve a response elicitation template;
creating a modified prompt by combining the response elicitation template and the first user prompt; and
generating the first natural-language response based on the modified prompt.

7. The method of claim 1, wherein generating the first-natural language response comprises:
receiving, by the network-connected device, a user identifier for the user;
querying, by the network-connected device, a first database using the user identifier to retrieve first information for the user;
querying a second database using the first information to retrieve a response elicitation template;
creating a modified prompt by combining the response elicitation template and the first user prompt; and
generating the first natural-language response based on the modified prompt.

8. The method of claim 7, wherein the first information is at least one of an account type, an account status, a recent purchase, and a service subscription.

9. The method of claim 8, and further comprising querying a third database using the user identifier to retrieve second information for the user, and wherein creating the modified prompt comprises combining the response elicitation template, the first user prompt, and the second information.

10. The method of claim 9, wherein the second user information is second user information is a different at least one of the account type, the account status, the recent purchase, and the service subscription.

11. The method of claim 1, and further comprising, prior to receiving the first user prompt, storing one or more natural-language text segments to a first database based on a user identifier for the user, and wherein generating the first-natural language response comprises:
receiving, by the network-connected device, the user identifier for the user;
querying, by the network-connected device, the first database using the user identifier to retrieve a response elicitation template;
creating a modified prompt by combining the response elicitation template and the first user prompt; and
generating the first natural-language response based on the modified prompt.

12. The method of claim 11, wherein the user identifier is at least one of a username, an account number, an account type, a recent purchase, and a service subscription.

13. The method of claim 1, and further comprising:
generating, by the language model executed by the network-connected device, a second natural-language response to the second user prompt, the second natural-language response configured to elicit second additional information describing the at least one technical support query; and
receiving, by the network-connected device, a third user prompt including the second additional information describing the at least one technical support query,
wherein generating the pre-summarization prompt for the language summarization model comprises generating the pre-summarization prompt based on the first user prompt, the second user prompt, and the third user prompt.

14. The method of claim 1, wherein generating the pre-summarization prompt comprises generating the pre-summarization prompt based on the first user prompt, the second user prompt, the third user prompt, the first natural-language response, and the second natural-language response.

15. The method of claim 1, and further comprising:
displaying, by the support technician device, an indication of the summarization; and
receiving, after displaying the indication of the summarization, a technician response at the support technician device, the technician response comprising one or more natural-language text segments describing a support solution for the at least one technical support query.

16. The method of claim 15, and further comprising:
transmitting the technician response from the support technician device to the user device; and
displaying, by the user device, an indication of the technician response.

17. A system for hybrid technical support, the system comprising:
a user device electronically-connected to a wide area network;
a server electronically-connected to the wide area network, the server comprising:
a processor; and
at least one memory encoded with instructions that, when executed, cause the processor to:
receive a first user prompt from the user device, the first user prompt including at least one technical support query;
generate a first natural-language response to the first user prompt using a language model, the first natural-language response configured to elicit first additional information describing the at least one technical support query;
receive a second user prompt from the user device, the second user prompt including the first additional information describing the at least one technical support query;
generate a pre-summarization prompt based on the first user prompt and the second user prompt;
generate a summarization of the pre-summarization prompt using a language summarization model executed by the processor, the language summarization model configured to generate summaries of text prompts; and
provide the summarization to a support technician device electronically-connected to the server and configured to be operated by a support technician.

18. The system of claim 17, wherein the instructions, when executed, cause the processor to generate the pre-summarization prompt based on the first user prompt, the second user prompt, and the first natural-language response.

19. The system of claim 17, and further comprising the support technician device, and wherein the instructions, when executed, cause the processor to provide the summarization to the support technician device by causing the server to transmit the summarization to the support technician device.

20. The system of claim 17, and further comprising a vector database electronically-connected to the server, and wherein the instructions, when executed, cause the processor to:
create a vector embedding of the first user prompt;
query a vector database with the vector embedding of the first user prompt to retrieve a response elicitation template;
create a modified prompt by combining the response elicitation template and the first user prompt; and
generate the first natural-language response based on the modified prompt.
